(19) United States
(12) Patent Application Publication
(10) Pub. No.: US 2002/0178146 A1
(43) Pub. Date: Nov. 28, 2002

(54) System and method for selective object history retention

(75) Inventors: Raji Lakshmi Akella, Austin, TX (US); Mark David Nielsen, Houston, TX (US); Patrick Edward Nogay, Austin, TX (US); Michael Albert Perks, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 09/864,111

(22) Filed: May 24, 2001

(51) Int. Cl. G06F 9/00; G06F 17/30; G06F 7/00

(52) U.S. Cl. 707/2

(57) ABSTRACT

A system and method for selectively retaining object history using a series of snapshots from a database is claimed. Rules are established for a database file or table to determine snapshot triggers. When a rule is triggered by an event, a snapshot is taken of a predefined set of database data. The snapshot is stored in a separate data area, such as a database table. Snapshots are queried and analyzed to determine historical trends. In addition, snapshot data can be overlaid onto the current database data in order to view changes in the data and also to facilitate record rollback using the snapshot data. When a rollback is requested, the current database record is copied to a new snapshot record and one of the snapshot records is overlaid onto the current database record creating a new database record. A transaction log is also maintained to record details regarding snapshot processing.

### BACKGROUND OF THE INVENTION

1. Technical Field

The present invention relates in general to a method and system for selectively retaining object history. Still more particularly, the present invention relates to an improved system and method for taking snapshots of predetermined data based upon a set of rules.

2. Description of the Related Art

Modern computer systems enable businesses and organizations to use large databases and other business systems to help manage business processes and tasks. Computer systems range from pervasive computing devices (such as personal digital assistants (PDAs)), to personal computer systems (such as IBM-compatible computer systems or Macintosh computers), to large mini- or mainframe computer systems that can support a number of connected users. These computer systems may be linked to one another using networking hardware and software. The computer networks linking the computer systems allow a given computer system to share a resource, such as a database, and allow distributed users to use the resource. Databases are typically stored on nonvolatile storage devices, such as magnetic disks.

Database systems are often managed by a database management system (DBMS) which handles the storing and retrieval of data. Various types of database systems are used such as relational database systems and hierarchical database systems. As the name implies, relational database systems store relationship data about database entities to allow for efficient use (i.e., non-redundant) use of storage and sophisticated retrieval mechanisms based upon keys, indices, and relationships. For example, a customer table may provide a customer number for each customer that orders goods along with many other pieces of information about the customer, such as the customer's billing address and phone number. An order table includes the customer's number along with the information about the customer's orders, such as product numbers, quantities, and prices. The common piece of information (the customer number) is used to relate the tables without having to repeat information from one table into the other table.

While database management systems, such as relational database systems, provide sophisticated management for an organization's data, they also present certain challenges with data archival and retrieval. Traditional database management systems have a function called “logging” that can be used to record changes made to the database. Logging files often become extremely large and are often stored offline, such as on a removable magnetic tape, or are rewritten so that the logging files do not inundate the nonvolatile storage area with such logging data. In addition, using the logging feature with a database management system often slows throughput and system performance because of the extra processing used by the logging function. While logging can sometimes be used to restore a database record to a previous state or to fix a database table that has become corrupted, it cannot be used to provide a visual “snapshot” of what a database table looked like at a certain point in time. Logging data is typically stored in one or more logging files which contain information about transactions but do not correlate in format or appearance with the database records as they previously existed. Because of these differences, users of traditional database management systems face challenges when querying or extracting data concerning the evolution of organizational data.

What is needed, therefore, is a way to provide historical snapshots of database data for historical queries, data warehousing, and data recover without unduly impacting the system's performance or space requirements.

### SUMMARY

It has been discovered that rules can be used to determine when a snapshot of a database record is taken. Rules include rules data, or the trigger mechanism, that determines when a snapshot is taken along with snapshot field data that determines which fields from a current database record are preserved in a snapshot. A transaction log can also be included to maintain information pertaining to the snapshot, such as when the snapshot was taken, by whom, and any reasons involved for the data change.

Historical snapshots are maintained in tables similar to the tables used to store the current database. A user can scroll through views of historical data pertaining to a customer or other entity included in the database. A “rollback” function can be performed by selecting an historical snapshot and instructing the system to revert back to the selected snapshot.

Snapshots are typically kept in separate tables from the current data to improve database search performance. Typically most inquiries are only needed for current data and therefore execute quicker if the snapshot data is held in a different table.

Because the historical snapshots are maintained in a format and structure similar to that of the current database, the snapshot data can be used not only for viewing older snapshots of data, but also for data warehousing, data mining, and ad hoc querying. Data warehousing and data mining functions allow the organization to learn about trends in the historical data. For example, data mining may enable an organization to determine that its customers, over time, have a tendency to move from one city to another and that it might be a good idea to open a branch office in the other city. Ad hoc queries allow the organization to query, or search, the data to determine, for example, if any of the customers lived in a particular city.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a system diagram showing rules being applied to database data to create historical snapshots;

FIG. 2 is a diagram showing snapshot rules being applied to a current record resulting in a new snapshot record and a transaction log record;

FIG. 3 is a field diagram showing sample fields used in an example snapshot rule, snapshot record, and transaction log;

FIG. 4 is a flowchart showing steps involved in setting up a database for snapshot processing;

FIG. 5 is a flowchart showing steps involved in creating a snapshot;

FIG. 6 is a flowchart showing steps involved in retrieving snapshots associated with one or more records;

FIG. 7 is a flowchart showing steps involved in using snapshot data to rollback a current database record to an older set of data; and

FIG. 8 is a block diagram of an information handling system capable of performing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

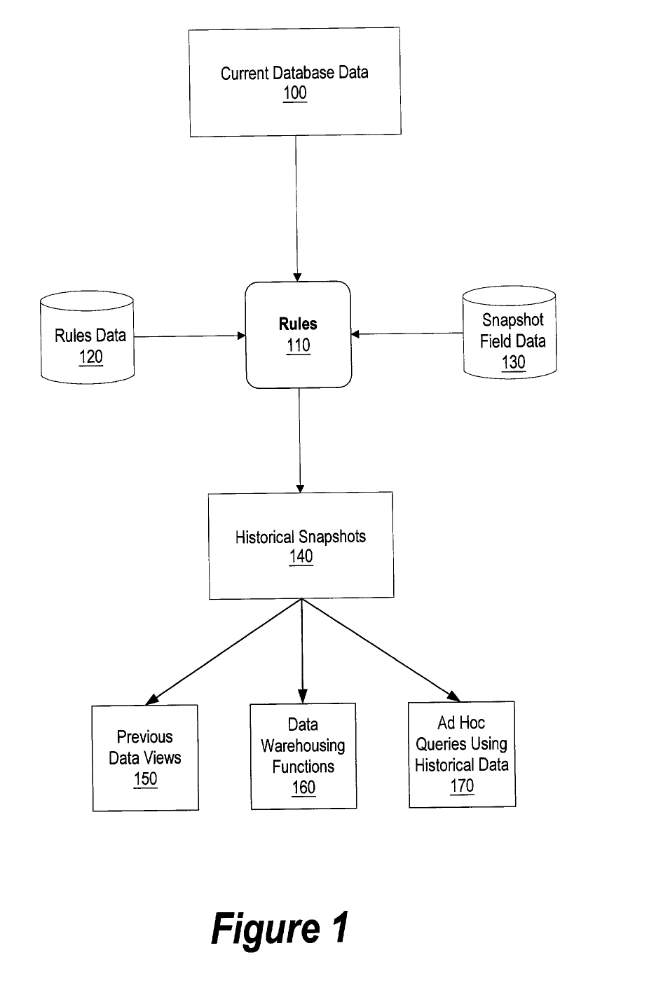

FIG. 1 is a system diagram showing rules being applied to database data to create historical snapshots. Current database data 100 includes the data as it currently applies to the organization. For example, a customer record in current database data 100 would include the current address and contact information for the customer. Rules process 110 applies one ore more rules from rules data 120 to the current database data to create a snapshot record. Snapshot field data 130 include data regarding which of the current database fields are maintained in historical snapshots.

An example of a rule may be that whenever a customer's address changes, a snapshot of the record should be taken and maintained in historical snapshots 140. Snapshot field data may be used to determine whether the entire customer record is recorded as an historical snapshot or whether a portion of the data is maintained. In addition, system defined fields, such as a timestamp when the snapshot was taken, which employee performed the transaction, and any reasons regarding the changed data may be maintained in a separate transaction log or as fields included with the historical snapshots.

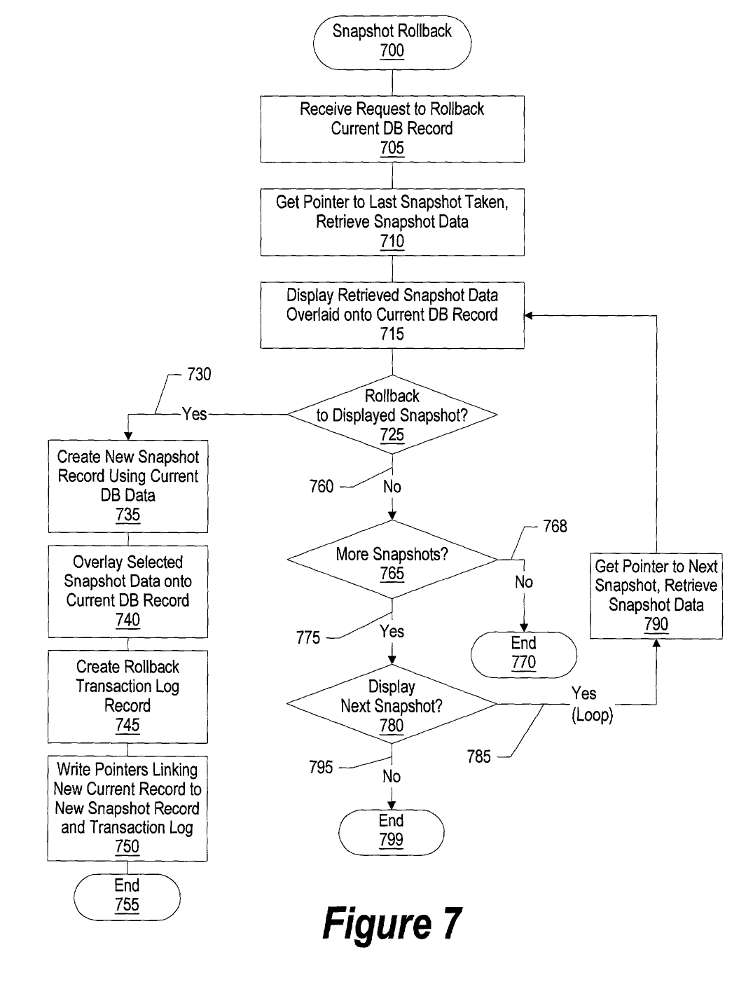

Historical snapshots 140 are used to provide the organization with previous data views 150 that can be used to view a database record as it existed at various points in time and also used in conjunction with a rollback function that is used to copy an historical snapshot record back to the current database (for more details regarding a rollback function using historical snapshots, see FIG. 7). Historical snapshots 140 are also used for data warehousing 160 which may include various data mining activities, used to analyze trends or other findings concerning the historical data. Ad hoc queries 170 are also performed using the historical snapshot data to further discover opportunities, trends, or mistakes that may be included within historical snapshots 140.

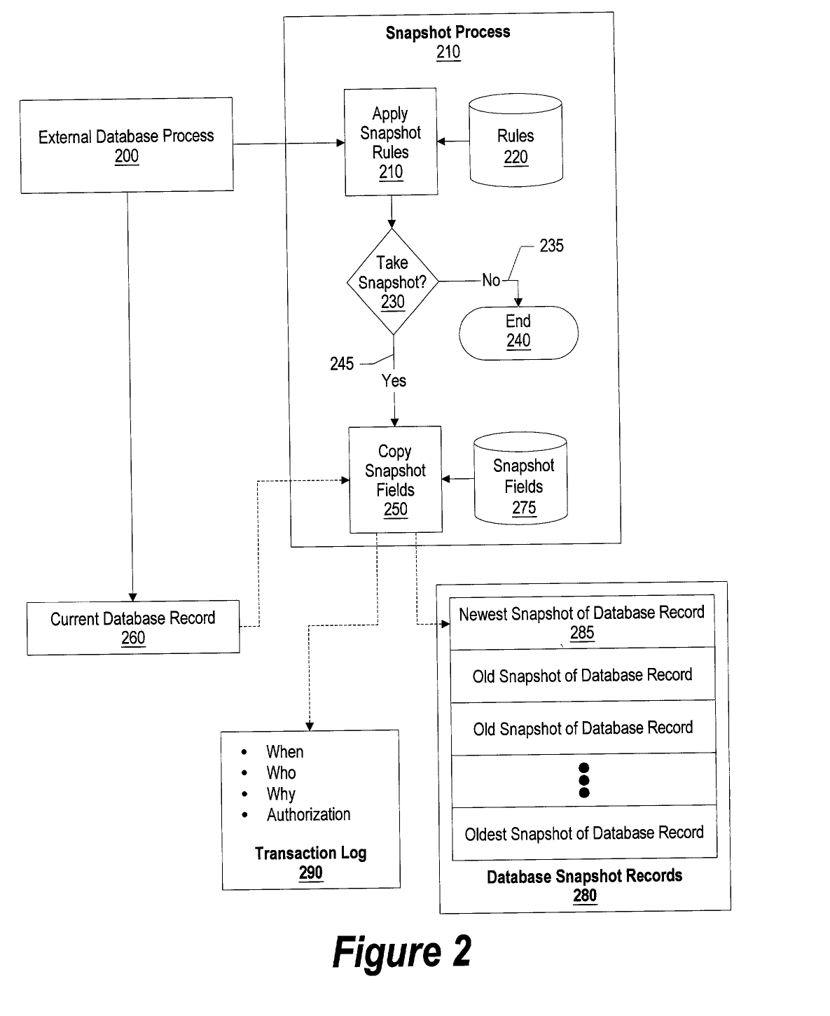

FIG. 2 is a diagram showing snapshot rules being applied to a current record resulting in a new snapshot record and a transaction log record. Snapshot processing may be incorporated within a database management system to enable the system to take snapshots of data whenever certain events occur triggering a snapshot. In addition, the snapshot processing could be implemented separately from the DBMS with an application program or utility program that is called and takes a snapshot when the events occur.

External database process 200 performs some action to the current database and invokes snapshot process 210. Snapshot process 210 applies snapshot rules 220 to the current database data (step 210). Ultimately, a decision is made as to whether the rules determine that a snapshot should be taken because of the changes made by external database process 200 (decision 230). If the rules determine that a snapshot need not be taken, “no” branch 235 is taken whereupon processing ends at 240. On the other hand, if the rules determine that a snapshot should be taken, decision 230 branches to “yes” branch 245 whereupon a snapshot is taken (step 250). Step 250 reads snapshot fields data 275 to determine which fields from current database record 260 are copied to database snapshot records 280. Step 250 writes newest snapshot record 285 to snapshot records 280. In addition, a record may be written to transaction log 290 detailing when the snapshot was taken, who made the change, why the change was made, and any authorization that was needed for the change. A relationship is formed between the transaction log record and the snapshot record so that a snapshot can be retrieved based on a given transaction record and a transaction record can be retrieved based on a given snapshot record. In addition, the relationship of the transaction log and the snapshot records allows a user to query all the snapshots created by a given employee or during a certain time period, or any other query using the transaction log fields.

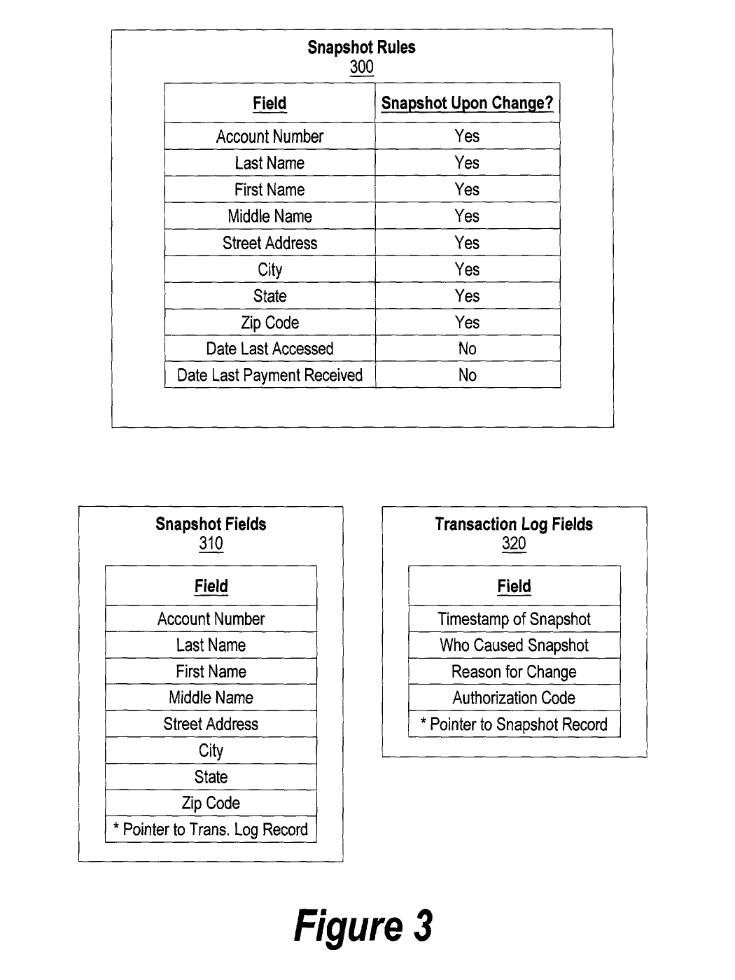

FIG. 3 is a field diagram showing sample fields used in an example snapshot rule, snapshot record, and transaction log. Snapshot rules 300 list sample rules that are used to determine whether a snapshot needs to be taken. In the example shown, fields from a particular table are listed along with a Boolean field that determines whether a snapshot is taken when the field is changed. In the example shown, a change to most fields (account number, last name, first name, middle name, street address, city, state, and zip code) causes a snapshot to be taken. However two other fields (date last accessed, date last payment received) do not cause a snapshot to be taken when the field is changed. While a simple example is shown, snapshot rules 300 could be implemented to use more complex rules, such as rules requiring multiple fields to be changed to trigger a snapshot or rules that cause a snapshot to be taken when data in another table is changed.

Snapshot fields 310 include those fields that are copied to the snapshot table when a snapshot is triggered. In the example shown, most fields from the sample table (account number, last name, first name, middle name, street address, city, state, and zip code) are copied to a snapshot record when a snapshot is taken, however two other fields (date last accessed and date last payment received) are not copied when a snapshot is taken. To reduce the amount of snapshot space taken, it would also be possible to only copy the zip code to the snapshot record and not copy the city and state since these fields can be derived from the zip code. Snapshot fields may also include fields that were not in the original database record. For example, a timestamp may be included as a snapshot field to record the date and time the snapshot record was created. In addition, a pointer is included in the snapshot fields relating the snapshot to a transaction log record that contains details about the snapshot transaction.

A transaction log may be maintained along with the snapshot records. Transaction log fields 320 details the fields included in a sample transaction log. In the example shown, the transaction log fields include a timestamp of the snapshot, the employee identifier of the person who caused the snapshot to be created, a reason for the change, any authorization codes that were needed to change the record, along with a pointer relating the transaction log record to its related snapshot record.

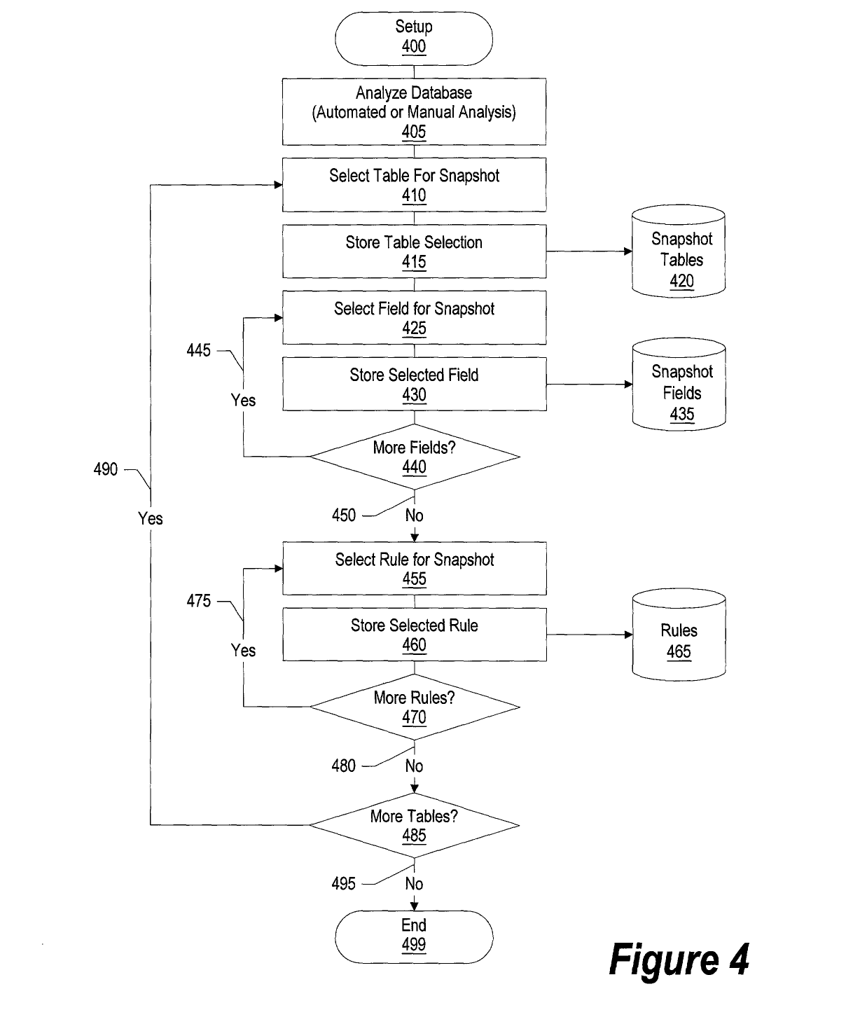

FIG. 4 is a flowchart showing steps involved in setting up a database for snapshot processing. Processing commences at 400 whereupon a database is analyzed to determine which tables are in the database and whether the tables should have snapshot records associated with them (step 405). The analysis may be automated, semi-automated, or a manual process. A table is selected from the database for which snapshot records wish to be maintained (step 410). The selected table is stored (step 415) in snapshot tables storage area 420 which also creates the structure of the snapshot table based upon the selected database table.

One or more fields are selected in order to determine which data from the selected database table are retained in a snapshot record. A field is selected from the list of available fields in the selected database table for which a copy is desired in the snapshot record (step 425). The selected field is stored (step 430) in snapshot fields data area 435. Additionally, the snapshot table is modified to include the selected field. A determination is made as to whether more fields should be included in the snapshot record (decision 440). If more fields are desired, decision 440 branches to “yes” branch 445 which loops back to select and store the next field. This looping continues until no more fields are desired in the snapshot record, at which time decision 440 branches to “no” branch 450.

One or more rules are selected (or created) in order to determine the triggers which cause a snapshot record to be recorded with the selected fields. A rule is selected or created from a list of available rules (or written if a new rule is needed) (step 455). The rule is stored (step 460) in rules data area 465 (for a simple example of a rules data are, see Snapshot Rules 300 in FIG. 3). A determination is made as to whether more rules are needed (decision 470). If more rules are desired, decision 470 branches to “yes” branch 475 which loops back to select (or create) and store the next rule. This looping continues until no more rules are desired for the snapshot, at which time decision 470 branches to “no” branch 480.

A determination is made as to whether other tables in the database should be processed to establish snapshot fields and rules for other tables (decision 485). If snapshots are desired for another table, decision 485 branches to “yes” branch 490 which loops back to process the next table. This looping continues until there are no more tables for which snapshots are desired, at which time decision 485 branches to “no” branch 495 and processing ends at 499.

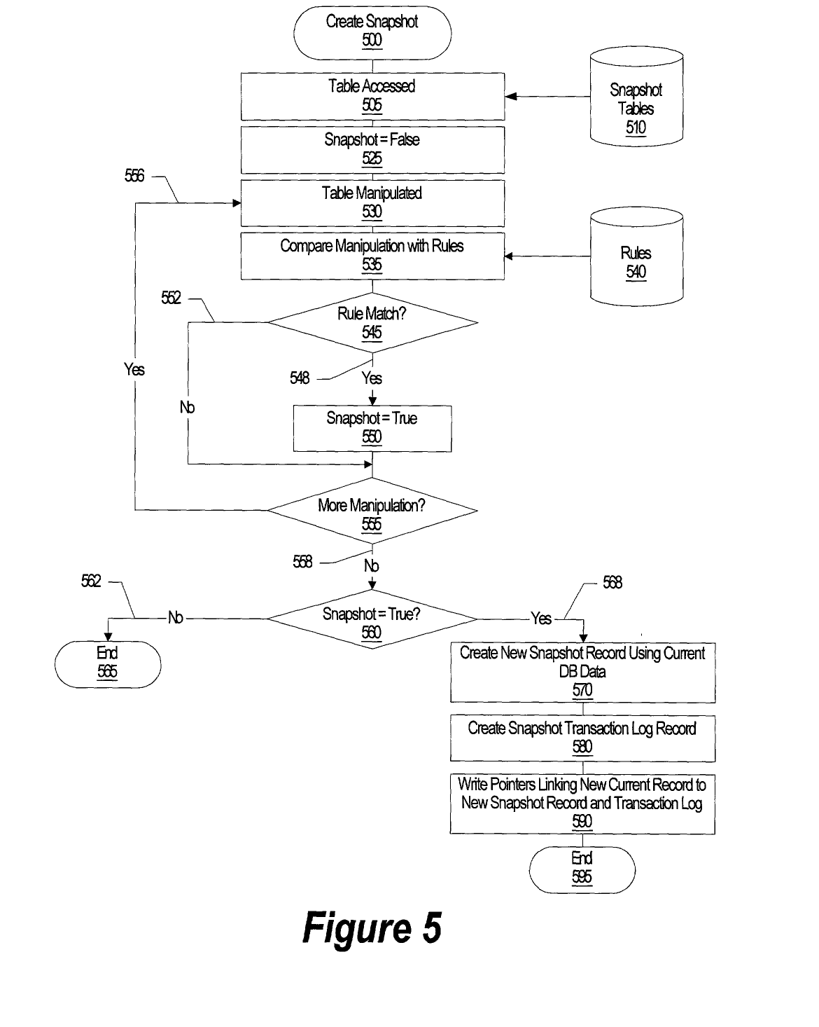

FIG. 5 is a flowchart showing steps involved in creating a snapshot. Processing commences at 500 whereupon a table is accessed by a user or process (step 505) and snapshot tables data area 510 is accessed to determine whether snapshots have been established for the accessed table. A snapshot flag is first initialized to “false” (step 525) because a condition to cause a snapshot has not yet been detected. The accessed table is manipulated (step 530) whereupon data from the table is retrieved or changed. The manipulation is compared (step 535) with one or more pre-established rules 540. A determination is made as to whether one of the rules matches the manipulation made to the table (decision 545). If a match is made, decision 545 branches to “yes” branch 548 whereupon the snapshot flag is set to “true” (step 550) indicating that a snapshot will be taken of the manipulated database record. On the other hand, if the rules do not match the manipulation, decision 545 branches to “no” branch 552 and the snapshot flag is not altered.

A determination is made as to whether more manipulations are made to the accessed database record (decision 555). If more manipulations are made, decision 555 branches to “yes” branch 556 which loops back to process the next manipulation. This looping continues until no more manipulations are made, at which time decision 555 branches to “no” branch 558.

A determination is made as to whether the snapshot flag was ever set to “true” (decision 560). If the snapshot flag was not set to true (i.e., flag is “false”), decision 560 branches to “no” branch 562 whereupon processing ends at 565 without making a snapshot of the manipulated database record. On the other hand, the snapshot flag was set to true, decision 560 branches to “yes” branch 568 whereupon a new snapshot record is created using the current database record data as snapshot material (step 570). A snapshot transaction log record is created (step 580) detailing the snapshot transaction (i.e., timestamp, employee that performed the snapshot, why the snapshot was performed, any authorization used to perform the snapshot, etc.). Pointers in the current database record, new snapshot record, and transaction log record are written (step 590) so that the database record, new snapshot record, and new transaction log record are related to one another. Snapshot processing then ends at 595.

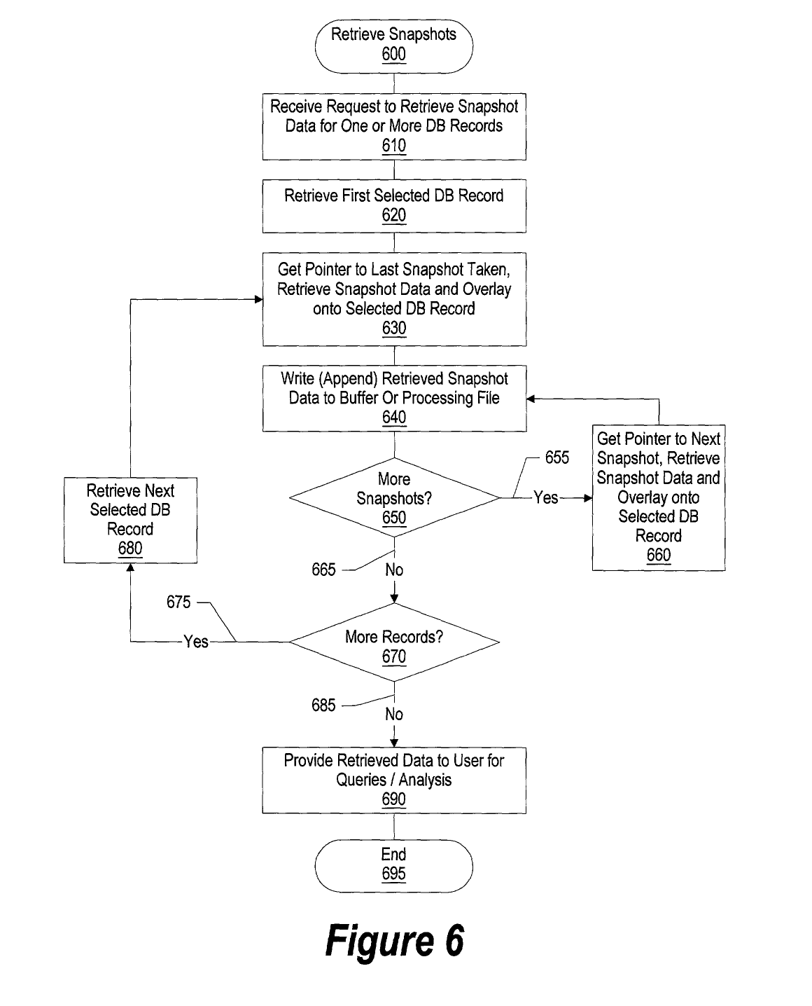

FIG. 6 is a flowchart showing steps involved in retrieving snapshots associated with one or more records. A request is received from a user or process to retrieve snapshot records corresponding to one or more database records (step 610). The first selected database record is retrieved (step 620). The database record includes a pointer to the last snapshot record that was taken. The pointer and the corresponding snapshot record is retrieved and the snapshot data is overlaid onto the selected database record (step 630). The overlaid fields from the snapshot records may be visually highlighted or otherwise note to indicate which fields from the snapshot record are different from the selected database record. The retrieved snapshot as overlaid on the selected database record is written to a data butter or processing table (step 640). A determination is made as to whether there are more snapshots corresponding to the selected database record (decision 650). If there are more snapshots corresponding to the selected database record, decision 650 branches to “yes” branch 655 and a pointer included with the last snapshot record is used to retrieve the next snapshot record and overlay the snapshot record onto the selected database record (step 660). Differences between the retrieved snapshots and each other and between each snapshot and the selected database record can be visually highlighted or otherwise noted. Processing then loops back to write the next snapshot to a data buffer or processing file/table (step 640). This looping continues until all snapshots corresponding to the selected database record have been retrieved and stored in the data buffer or processing file/table, at which time decision 650 branches to “no” branch 665.

A determination is made as to whether more database records have been selected for which corresponding snapshots need to be retrieved (decision 670). If more database records need to be processed, decision 670 branches to “yes” branch 675 whereupon the next selected database record is retrieved (step 680) and processing loops back to retrieve this record's snapshot records. This looping continues until there are no more database records to process, at which time decision 670 branches to “no” branch 685 whereupon the retrieved data that was stored in the buffer or processing file/table is provided to the user or process for queries and other analyses. Retrieve snapshot processing thereupon ends at 695.

FIG. 7 is a flowchart showing steps involved in using snapshot data to rollback a current database record to an older set of data. Processing commences at 700 whereupon a request is received from a user or process to rollback a current database record using snapshot data (step 705). A pointer in the current database record is used to retrieve the last snapshot record taken that corresponds to the current database record. This pointer is used to retrieve the last snapshot record that was taken (step 710). The retrieved snapshot data is overlaid onto the current database record and displayed to the user (step 715). The display may also visually highlight differences between the current database record and the snapshot data so that the user can easily see which fields are different between the current database record and the snapshot record. A determination is made as to whether the current database record should be revised using the displayed snapshot data (decision 725). Decision 725 may be in response to a user selecting an option on a display screen or may be part of an automated or semi-automated process. If the current database record is rolled back using the snapshot record, decision 725 branches to “yes” branch 730 to perform the rollback operation. A new snapshot record is created using the current database record data as snapshot material since the current database record is about to be rolled back (step 735). The selected snapshot record is used to overlay the current database record and create a revised current database record (step 740) which is saved in the database. A rollback transaction log record is created (step 745) detailing the rollback transaction (i.e., timestamp, employee that performed the rollback, why the rollback was performed, any authorization used to perform the rollback, etc.). Pointers in the revised current database record, new snapshot record, and transaction log record are written (step 750) so that the revised database record, new snapshot records and new transaction log record are related to one another. Rollback processing then ends at 755.

On the other hand, if the displayed snapshot record is not selected to be used for rollback processing, decision 725 branches to “no” branch 760. A determination is made whether any more snapshots exist for the current database record (decision 765). If there are no more snapshot records to retrieve and display, decision 765 branches to “no” branch 768 whereupon processing ends at 768 without rolling the current record back using a snapshot record. On the other hand, if there are more snapshots corresponding to the current database record, decision 765 branches to “yes” branch 775 whereupon a determination is made as to whether the user wishes to display more snapshots (decision 780). If the user wishes to display the next snapshot, decision 780 branches to “yes” branch 785 which gets the pointer and retrieves the next snapshot record (step 790) before looping back to display and process the next snapshot record. This looping continues until one of the snapshots is selected (“yes” branch 730), there are no more snapshots to retrieve (“no” branch 768), or the user decides not to display more snapshots (“no” branch 795), at which time snapshot rollback processing ends at 799.

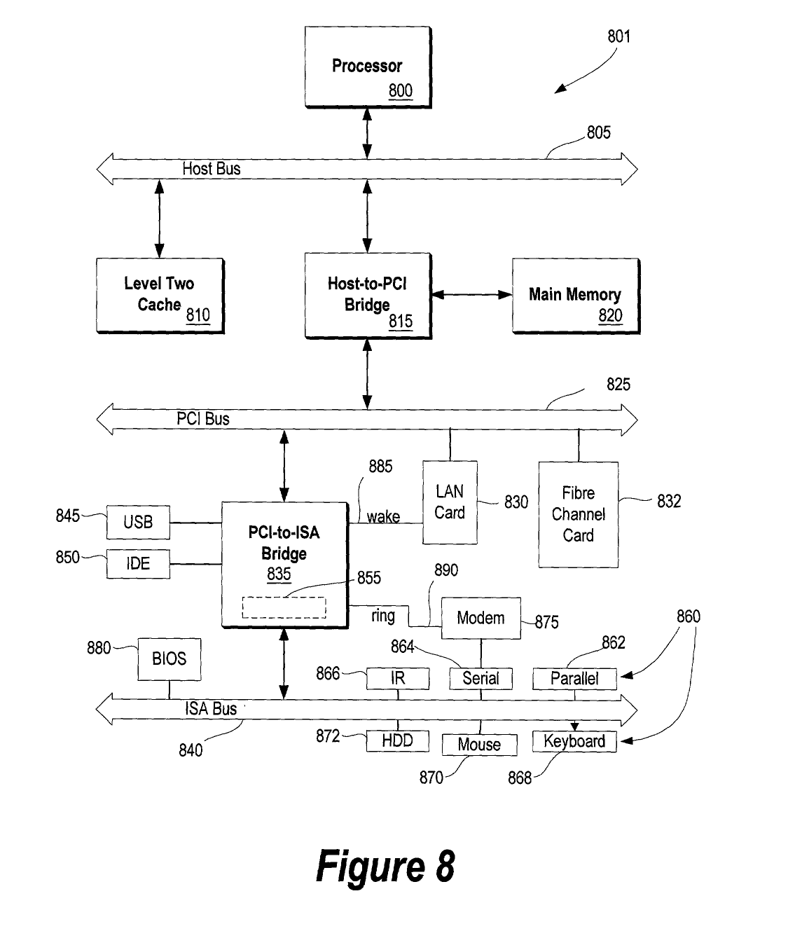

FIG. 8 illustrates information handling system 801 which is a simplified example of a computer system capable of performing the copy processing described herein. Computer system 801 includes processor 800 which is coupled to host bus 805. A level two (L2) cache memory 810 is also coupled to the host bus 805. Host-to-PCI bridge 815 is coupled to main memory 820, includes cache memory and main memory control functions, and provides bus control to handle transfers among PCI bus 825, processor 800, L2 cache 810, main memory 820, and host bus 805. PCI bus 825 provides an interface for a variety of devices including, for example, LAN card 830. PCI-to-ISA bridge 835 provides bus control to handle transfers between PCI bus 825 and ISA bus 840, universal serial bus (USB) functionality 845, IDE device functionality 850, power management functionality 855, and can include other functional elements not shown, such as a real-time clock (RTC), DMA control, interrupt support, and system management bus support. Peripheral devices and input/output (I/O) devices can be attached to various interfaces 860 (e.g., parallel interface 862, serial interface 864, infrared (IR) interface 866, keyboard interface 868, mouse interface 870, and fixed disk (FDD) 872) coupled to ISA bus 840. Alternatively, many I/O devices can be accommodated by a super I/O controller (not shown) attached to ISA bus 840.

BIOS 880 is coupled to ISA bus 840, and incorporates the necessary processor executable code for a variety of low-level system functions and system boot functions. BIOS 880 can be stored in any computer readable medium, including magnetic storage media, optical storage media, flash memory, random access memory, read only memory, and communications media conveying signals encoding the instructions (e.g., signals from a network). In order to attach computer system 801 another computer system to copy files over a network, LAN card 830 is coupled to PCI-to-ISA bridge 835. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the copying processes described herein, this computer system is simply one example of a computer system. Those skilled in the art will appreciate that many other computer system designs are capable of performing the copying process described herein.

One of the preferred implementations of the invention is a client application, namely, a set of instructions (program code) in a code module which may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that is a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of creating snapshots of a data record, said method comprising:
determining one or more changes to the data record;
comparing the changes to one or more rules; and
copying one or more fields from the data record to a snapshot record in response to the comparison.

2. The method as described in claim 1 further comprising:
writing transaction data corresponding to the copying to a transaction log file, wherein the transaction data includes an address corresponding to the snapshot record.

3. The method as described in claim 2 further comprising:
retrieving one or more transaction records stored in the transaction log file; and
selecting a related snapshot record corresponding to each of the retrieved transaction log records.

4. The method as described in claim 1 further comprising:
including a snapshot pointer in the data record that includes an first address corresponding to the snapshot record; and
including a data record pointer in the snapshot record that includes a second address corresponding to the data record.

5. The method as described in claim 1 further comprising:
retrieving one or more snapshot records corresponding to the data record;
analyzing the retrieved snapshot records; and
displaying a resulting analysis.

6. The method as described in claim 1 further comprising:
retrieving one or more snapshot records corresponding to the data record;
identifying one of the retrieved snapshot records as a rollback record; and
creating a new data record by overlaying the data record with the rollback record.

7. The method as described in claim 1 further comprising:
reading the rules from a rules data area; and
identifying the fields from a snapshot fields data area.

8. An information handling system comprising:
one or more processors;
a memory accessible by the processors;
a nonvolatile storage accessible by the processors;
one or more data records stored on the nonvolatile storage; and
a snapshot tool for creating snapshots of a data record, the snapshot tool including:
means for determining one or more changes to the data record;
means for comparing the changes to one or more rules; and
means for copying one or more fields from the data record to a snapshot record in response to the comparison.

9. The information handling system as described in claim 8 further comprising:
means for writing transaction data corresponding to the copying to a transaction log file, wherein the transaction data includes an address corresponding to the snapshot record.

10. The information handling system as described in claim 9 further comprising:
means for retrieving one or more transaction records stored in the transaction log file; and
means for selecting a related snapshot record corresponding to each of the retrieved transaction log records.

11. The information handling system as described in claim 8 further comprising:
means for including a snapshot pointer in the data record that includes an first address corresponding to the snapshot record; and
means for including a data record pointer in the snapshot record that includes a second address corresponding to the data record.

12. The information handling system as described in claim 8 further comprising:
means for retrieving one or more snapshot records corresponding to the data record;
means for analyzing the retrieved snapshot records; and
means for displaying a resulting analysis.

13. The information handling system as described in claim 8 further comprising:
means for retrieving one or more snapshot records corresponding to the data record;
means for identifying one of the retrieved snapshot records as a rollback record; and
means for creating a new data record by overlaying the data record with the rollback record.

14. The information handling system as described in claim 8 further comprising:
means for reading the rules from a rules data area; and
means for identifying the fields from a snapshot fields data area.

15. A computer program product stored on a computer operable medium for creating snapshots of a data record, said computer program product comprising:
means for determining one or more changes to the data record;
means for comparing the changes to one or more rules; and
means for copying one or more fields from the data record to a snapshot record in response to the comparison.

16. The computer program product as described in claim 14 further comprising:
means for writing transaction data corresponding to the copying to a transaction log file, wherein the transaction data includes an address corresponding to the snapshot record.

17. The computer program product as described in claim 15 further comprising:
means for retrieving one or more transaction records stored in the transaction log file; and
means for selecting a related snapshot record corresponding to each of the retrieved transaction log records.

18. The computer program product as described in claim 14 further comprising:
means for including a snapshot pointer in the data record that includes an first address corresponding to the snapshot record; and
means for including a data record pointer in the snapshot record that includes a second address corresponding to the data record.

19. The computer program product as described in claim 14 further comprising:
means for retrieving one or more snapshot records corresponding to the data record;
means for analyzing the retrieved snapshot records; and
means for displaying a resulting analysis.

20. The computer program product as described in claim 14 further comprising:
means for retrieving one or more snapshot records corresponding to the data record;
means for identifying one of the retrieved snapshot records as a rollback record; and
means for creating a new data record by overlaying the data record with the rollback record.

21. The computer program product as described in claim 14 further comprising:
means for reading the rules from a rules data area; and
means for identifying the fields from a snapshot fields data area.
